(19) United States
(12) Patent Application Publication
(10) Pub. No.: US 2009/0026750 A1
(43) Pub. Date: Jan. 29, 2009

(54) Method of creating booklet cover and booklet cover kit

(75) Inventor: Takemi Yamamoto, Aichi (JP)

Correspondence Address: SNIDER & ASSOCIATES, P. O. BOX 27613, WASHINGTON, DC, 20038-7613, US

(73) Assignee: LAB, AT-SITE, LTD, NAGOYA-SHI, AICHI (JP)

(21) Appl. No.: 11/886,955

(22) PCT Filed: Apr. 4, 2006
(86) PCT No.: PCT/JP2006/307075

§ 371 Date: Sep. 24, 2007

(30) Foreign Application Priority Data
Apr. 6, 2005 (JP) 2005-109904

(51) Int. Cl. B42D 3/00; B42C 1/00; B42C 9/00

(52) U.S. Cl. 281/29; 412/4; 412/8

(57) ABSTRACT

A peeling sheet on the back of a cover sheet is provided with a cover seal having a printed front surface is peeled off to partially expose an adhesive layer. A core material for cover is placed thereon. First side piece portion and second side piece portion are then peeled off and the entire surface of the first cover members, backbone member and second cover member of the core material for cover is bonded and fixed by the adhesive layer of the cover sheet for cover. Outer circumferential region of the cover seal for cover is then bent to the inside thus making a cover of a booklet. When a personal user edits electronic images and prints the electronic images on a printed sheet, the printed sheet can be fixed easily in a short time for making a booklet.

### RELATED APPLICATIONS

This application claims the priority of Japanese Patent Application No. 2005-109904 filed on Apr. 6, 2005, which is incorporated herein by reference.

### FIELD OF THE INVENTION

This invention relate to the method for making cover of booklet and kit for making cover of booklet which is made by the printing paper where the picture and the like is printed.

### BACKGROUND OF TECHNOLOGY

Enjoying the electronic image photographed by the spread of digital cameras etc. is also spread, and appreciating image data on the monitor of a personal computer, or editing this image data is performed. And the data is saved at archival medium, such as a hard disk and a compact disk, or is printing with the printer. Moreover, such image data is printed in pasteboard or printing paper, and a book is bound as an album made of paper, and it can leave commemoration and it can be enjoyed, or it can carry out. Compared with the album which stuck the photograph, it is the sensation of an original copy book which printed directly in such pasteboard or printing paper, and bound a book in them, and it can enjoy an image. And in order to create such an album wherein electronic image data is saved at an archival medium, it carries into a specific contractor or bookbinding is requested for data as delivery and an individual album through the Internet.

However, in this way, in order to print and bookbinding a image directly in pasteboard or printing paper, a vendor must be requested, the approach of an order is troublesome, or remarkable days are taken to be in the condition that a book was bound, and it is hard to say that an electronic image can be easily bookbinding in the state of the album made of paper. If it is the approach of printing only an image and on the other hand sticking the printed image on a ready-made album, an individual can also carry out easily, but a cheap impression cannot be denied if compared with what was bookbinding. Photography becomes possible by the spread of digital cameras, and the approach of bookbinding those images easily is desired.

For an expert or an individual use, it is disclosed the printing paper which can create the booklet in the condition of having printed the direct image in pasteboard or in printing paper, and disclosed the book cover to make booklet easily and promptly. (patent literature 1)

[patent literature 1] Jp 2004/358810

But there are problems and subjects which explain below.

The cover was made from ready-made ones and it was not possible to make order-made ones easily and promptly.

The purpose of this invention is to disclose the printing paper which can create the booklet in the condition of having printed the direct image in pasteboard or in printing paper, and to disclose the book cover to make booklet easily and promptly for the expert or the individual use.

### SUMMARY OF THE INVENTION

In order to solve the above mentioned technical problems, the method for making cover of booklet is proposed below.

The booklet cover creation method which has cover sheet and cover core components. Said cover sheet is formed with the cover seal on which adhesion layer is formed to reverse side and the releasing paper is formed the next layer of said adhesion layer. Said releasing paper is possible to release from said cover seal. Said releasing paper is formed with more than two cutting lines from the edge of one side to the other edge to longitudinal direction.

Said cover core components have the backbone component for the back cover of booklet and the first cover component which is place to next of said backbone component with some space and the second cover component which is place to the opposite side to said first cover component and the framework-body component which can separate from said backbone component and said first cover component and said second cover component.

A part of said releasing paper is peeled off and said cover sheet is placed on the first surface of said cover core components and said first cover component, said second cover component and said backbone component are adhered and fixed by said adhesive layer of said cover seal.

Said framework-body is taken off and rest of said releasing paper is peeled off.
Said cover seal connect said first cover component and second cover component and backbone component and said outer area of cover seal is bent and overlapped on said cover components. The booklet cover is created by using said cover sheet and said cover core components.
Prepare the preprinted cover sheet and a part of said releasing paper of said preprinted cover sheet is peeled off and said cover sheet is placed on the first surface of said cover core components and said first cover component said second cover component and said backbone component are adhered and fixed by said adhesive layer of said preprinted cover seal.
And it is possible to make decoration on the surface of booklet cover by hand painting.
By the above-mentioned method, it is possible to make the booklet cover which is user selected color or painted picture, because of the connection to said cover core components by using the adhesive layer of said cover sheet. In order to solve the above mentioned technical problems, the method for making cover of booklet is proposed below. The booklet cover creation method which has base sheet and cover core components and cover material for cover sheet

Said base sheet is formed with both sides pressure sensitive sheet on which the first releasing paper is formed on the top layer of said first adhesion layer and the first adhesion layer is formed on the core sheet of said base sheet. Said releasing paper is possible to release from said base sheet. Said releasing paper is formed with more than two cutting lines from the edge of one side to the other edge to longitudinal direction and on which the second releasing paper is formed on the bottom layer of said second adhesion layer and the second adhesion layer is formed on the reverse side of core sheet of said base sheet. Said releasing paper is formed with more than two cutting lines from the edge of one side to the other edge to longitudinal direction.

Said cover material for cover sheet

Said cover core components have the backbone component for the back cover of booklet and the first cover component which is place to next of said backbone component with some space and the second cover component which is place to the opposite side to said first cover component and the framework-body component which can separate from said backbone component and said first cover component and said second cover component.

A part of said first releasing paper is peeled off and said cover material for cover sheet is fixed partially on said base sheet and the rest of said releasing paper is peeled off and said cover material for cover sheet is fixed totally. And then after or before, a part of said second releasing paper is peeled off and said base sheet is placed on the first surface of said cover components.

Said first cover component, said second cover component and said backbone component are adhered and fixed partially by said adhesive layer of said base sheet with said cover material for cover sheet.
Said framework-body is taken off and rest of said releasing paper is peeled off.
Said base sheet connect said first cover component and second cover component and backbone component and outer area of said base sheet with said cover material for cover sheet is bent and overlapped on said cover components.
The booklet cover is created by using said base sheet and said cover material for cover sheet and said cover core components. By the above-mentioned method, it is possible to make the booklet cover which is user selected paper or cloth, because of the connection to said cover core components by using the adhesive layer of said both sides pressure sensitive base sheet.
The booklet cover creation method which said first cover component, said second cover component and said backbone component are adhered and fixed partially by said adhesive layer of said base sheet with said cover material for cover sheet.
Said framework-body is taken off and the four corners of said base sheet with said cover material for cover sheet is cut down and then, rest of said releasing paper is peeled off. Said base sheet with said cover material for cover sheet connect said first cover component and second cover component and backbone component and outer area of said base sheet with said cover material for cover sheet is bent and overlapped on said cover components.
By connecting said cover sheet and said base sheet and cutting down said four corners,
it is easier to make bending and overlapping on said cover component for booklet cover.

In order to solve the above mentioned technical problems, the method for making cover of booklet is proposed below.

The booklet cover creation kit in which the printable cover sheet is prepared

Said cover sheet is formed with the cover seal on which adhesion layer is formed to reverse side and the releasing paper is formed the next layer of said adhesion layer. Said releasing paper is possible to release from said cover seal. Said releasing paper is formed with more than two cutting lines from the edge of one side to the other edge to longitudinal direction.

Said cover core components have the backbone component for the back cover of booklet and the first cover component which is place to next of said backbone component with some space and the second cover component which is place to the opposite side to said first cover component and the framework-body component which can separate from said backbone component and said first cover component and said second cover component.

A part of said releasing paper is peeled off and said cover sheet is placed on the first surface of said cover core components and said first cover component, said second cover component and said backbone component are adhered and fixed by said adhesive layer of said cover seal.

Said framework-body is taken off and rest of said releasing paper is peeled off.
Said cover seal connect said first cover component and second cover component and backbone component and said outer area of cover seal is bent and overlapped on said cover components. The booklet cover is created by using said cover sheet and said cover core components.

On the surface of cover sheet, users can print the pattern or color what they like. Adhesive layer is formed on cover sheet and it is easily connect to said cover core components. Releasing paper on said adhesive layer is formed by more than two cutting lines, and it is possible to release a part of releasing paper.

Remaining other releasing paper, it is possible to connect the cover sheet to the first cover component and second cover component and backbone component. To do said connection, it is possible to retry to connect the said cover sheet and said core cover component because of weak adhesion if the placement is wrong.

After the good placement with said cover sheet and said first cover component and second cover component and backbone component, outer area of cover seal is bent and overlapped on said cover components.

Releasing paper of said cover sheet have center belt zone which is formed in center from the edge of one side to the other edge to longitudinal direction and both sides of said center belt zone are the first side of said releasing paper and the second side of said releasing paper. To do this formation and peeling off said releasing central belt zone paper makes soft connection with cover sheet to said first cover component and second component and backbone component. After good placement of cover sheet, the said first side of releasing paper and said second side of releasing paper are peeled off and the said cover sheet connect strongly to cover core components.

The booklet cover creation kit is recommended to use the cover seal of which four corners of cover seal of said cover sheet are cut down. Using said seal, it is easier to bend and overlapped to cover core components which are the first core component and second core component and backbone component. In order to solve the above mentioned technical problem, the method for making cover of booklet is proposed below. The booklet cover creation kit which has base sheet and cover core components and cover material for cover sheet.

Said base sheet is formed with both sides pressure sensitive sheet on which the first releasing paper is formed on the top layer of said first adhesion layer and the first adhesion layer is formed on the core sheet of said base sheet. Said releasing paper is possible to release from said base sheet and on which the second releasing paper is formed on the bottom layer of said second adhesion layer and the second adhesion layer is formed on the reverse side of core sheet of said base sheet. Said releasing paper is formed with more than two cutting lines from the edge of one side to the other edge to longitudinal direction.

Said cover core components have the backbone component for the back cover of booklet and the first cover component which is place to next of said backbone component with some space and the second cover component which is place to the opposite side to said first cover component and the framework-body component which can separate from said backbone component and said first cover component and said second cover component.

A part of said first releasing paper is peeled off and said cover material for cover sheet is fixed partially on said base sheet and the rest of said releasing paper is peeled off and said cover material for cover sheet is fixed totally. And then after or before, a part of said second releasing paper is peeled off and said base sheet is placed on the first surface of said cover components.
Said first cover component, said second cover component and said backbone component are adhered and fixed partially by said adhesive layer of said base sheet with said cover material for cover sheet.
Said framework-body is taken off and rest of said releasing paper is peeled off.
Said base sheet connect said first cover component and second cover component and backbone component and outer area of said base sheet with said cover material for cover sheet is bent and overlapped on said cover components.
The booklet cover is created by using said base sheet and said cover material for cover sheet and said cover core components.

Using said components and peeling off the first releasing paper, users can adhere the cover material for booklet what they like. Adhesive layer is formed on base sheet and it is easily connect to cover core components. Said second releasing paper on said adhesive layer is formed by more than two cutting lines, and it is possible to release a part of releasing paper.

Remaining other releasing paper, it is possible to connect the cover sheet to the first cover component and second cover component and backbone component. To do said connection, it is possible to retry to connect the said cover sheet and said core cover component because of soft adhesion if the placement is wrong.
After the good placement with said cover sheet and said first cover component and second cover component and backbone component, outer area of cover seal is bent and overlapped on said cover components.
In order to solve the above mentioned technical problem, the method for making cover of booklet is proposed below. The booklet cover creation kit which has base sheet and cover core components and cover material for cover sheet.

Said base sheet is formed with both sides pressure sensitive sheet on which the first releasing paper is formed on the top layer of said first adhesion layer and the first adhesion layer is formed on the core sheet of said base sheet. Said releasing paper is possible to release from said base sheet. Said releasing paper is formed with more than two cutting lines from the edge of one side to the other edge to longitudinal direction and on which the second releasing paper is formed on the bottom layer of said second adhesion layer and the second adhesion layer is formed on the reverse side of core sheet of said base sheet. Said releasing paper is formed with more than two cutting lines from the edge of one side to the other edge to longitudinal direction.

Said cover core components have the backbone component for the back cover of booklet and the first cover component which is place to next of said backbone component with some space and the second cover component which is place to the opposite side to said first cover component and the framework-body component which can separate from said backbone component and said first cover component and said second cover component.

A part of said first releasing paper is peeled off and said cover material for cover sheet is fixed partially on said base sheet and the rest of said releasing paper is peeled off and said cover material for cover sheet is fixed totally. And then after or before, a part of said second releasing paper is peeled off and said base sheet is placed on the first surface of said cover components.

Said first cover component, said second cover component and said backbone component are adhered and fixed partially by said adhesive layer of said base sheet with said cover material for cover sheet.
Said framework-body is taken off and rest of said releasing paper is peeled off.
Said base sheet connect said first cover component and second cover component and backbone component and outer area of said base sheet with said cover material for cover sheet is bent and overlapped on said cover components.
The booklet cover is created by using said base sheet and said cover material for cover sheet and said cover core components.

Using said components and peeling off the first releasing paper, users can adhere the cover material for booklet what they like. Adhesive layer is formed on base sheet and it is easily connect to cover core components. Said first releasing paper on said adhesive layer is formed by more than two cutting lines, and it is possible to release a part of releasing paper. It is possible to connect to base sheet easily because of soft adhesion

Adhesive layer is formed on base sheet and it is easily connect to cover core components. Said second releasing paper on said adhesive layer is formed by more than two cutting lines, and it is possible to release a part of releasing paper. Remaining other releasing paper, it is possible to connect the cover sheet to the first cover component and second cover component and backbone component. To do said connection, it is possible to retry to connect the said cover sheet and said core cover component because of soft adhesion if the placement is wrong. After the good placement with said cover sheet and said first cover component and second cover component and backbone component, outer area of cover seal is bent and overlapped on said cover components.
The booklet creation kit is formed that the first releasing paper of said both sides pressure sensitive base sheet have center belt zone which is formed in center from the edge of one side to the other edge to longitudinal direction and both sides of said center belt zone are the first side of said releasing paper and the second side of said releasing paper. Using said formation, it is possible to make soft adhesion with the base sheet and booklet cover sheet by peeling off the center belt zone releasing paper. After making good placement with base sheet and booklet cover sheet, and peeling off the first side releasing paper and second side releasing paper, it is possible to make hard adhesion with base sheet and booklet cover sheet.
The booklet creation kit is formed that the second releasing paper of said both sides pressure sensitive base sheet have center belt zone which is formed in center from the edge of one side to the other edge to longitudinal direction and both sides of said center belt zone are the first side of said releasing paper and the second side of said releasing paper.
Using said formation, it is possible to make soft adhesion with the base sheet and cover core components by peeling off the center zone releasing paper. After making good placement with base sheet and cover core components, and peeling off the first side releasing paper and second side releasing paper, it is possible to make hard adhesion with base sheet and cover core components.

The booklet creation kit is formed that the cover sheet is installed for the purpose of adhesion to said both sides pressure sensitive base sheet.

If multi-booklet cover is installed, users can select the cover what they like and make favorite booklet cover.

The booklet creation kit is formed that both sides pressure sensitive base sheet is formed four cutting lines for cut down.

Using said formation, it makes easier to bent and overlap. After the good placement with said cover sheet and said first cover component and second cover component and backbone component, outer area of cover seal is bent and overlapped on said cover components.
The booklet creation kit is formed that the both sides pressure sensitive auxiliary materials are installed that the first releasing paper is formed on the top layer of said first adhesion layer and is possible to release from said base sheet and is formed largely in longitudinal and the second releasing paper is formed on the top layer of said second adhesion layer and is possible to release from said base sheet.

And said second releasing paper is peeled off and is connect to booklet cover then said first releasing paper is peeled off and connect to printing paper which is printed and folded to booklet.

Using said formation, it is possible to make good hard adhesion with folded printing paper and booklet cover

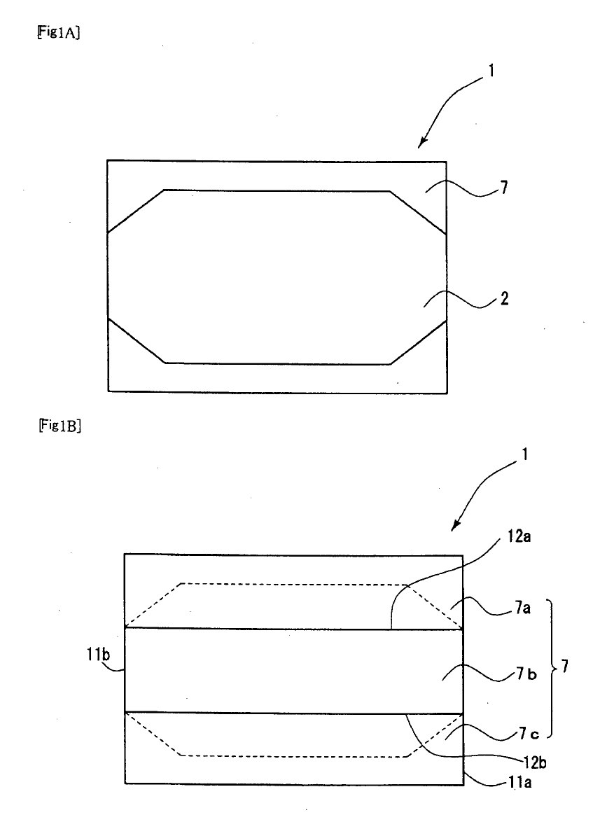

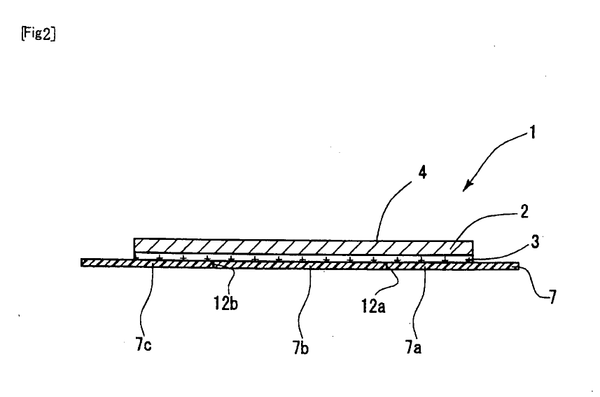

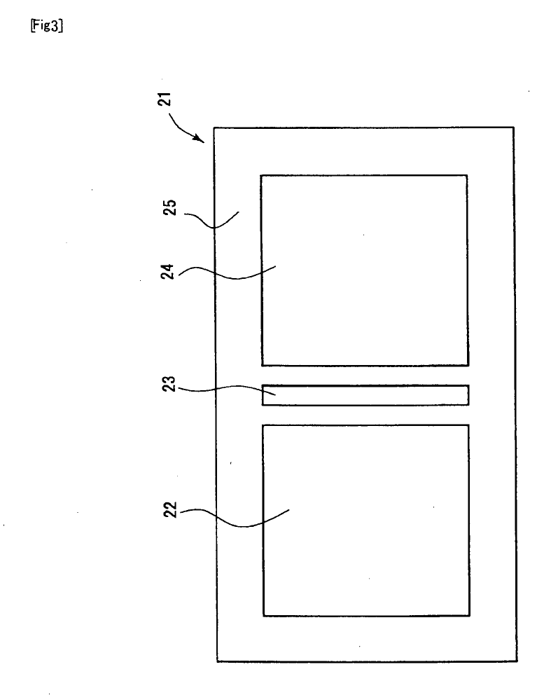

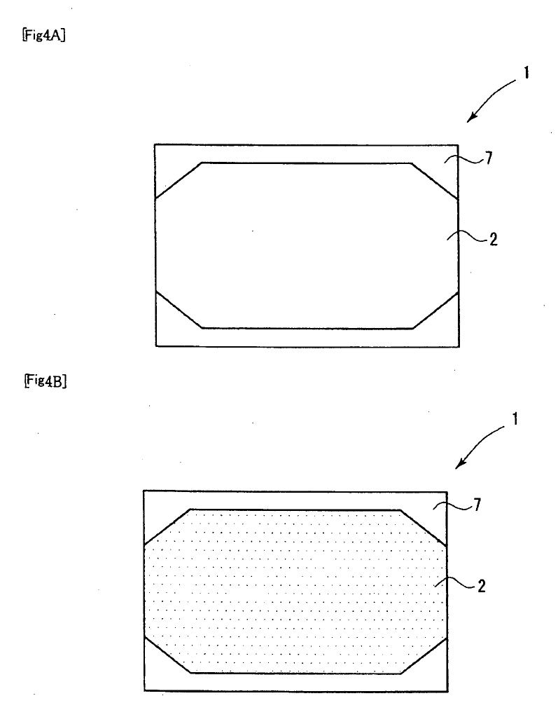

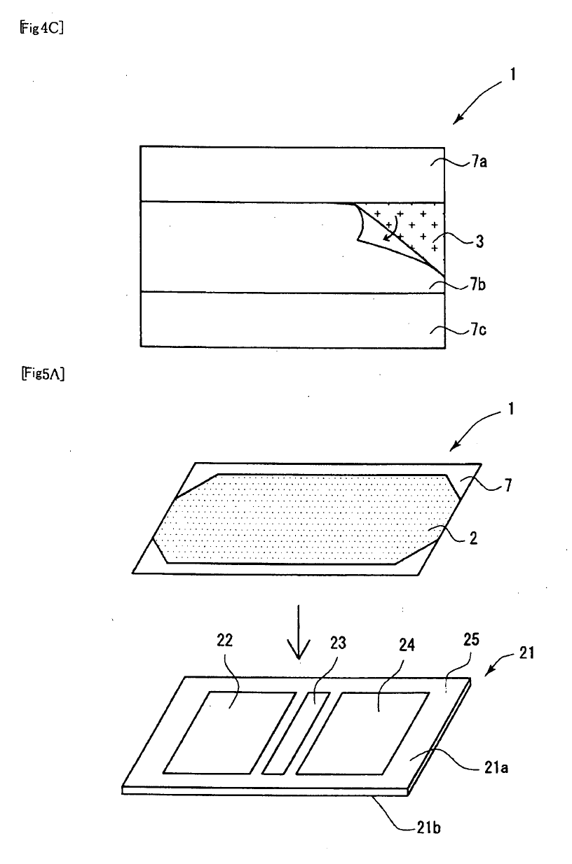

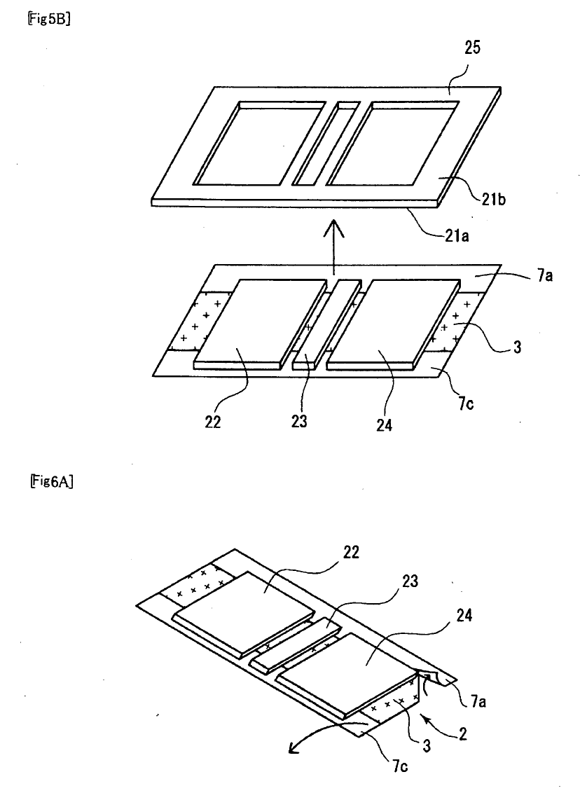

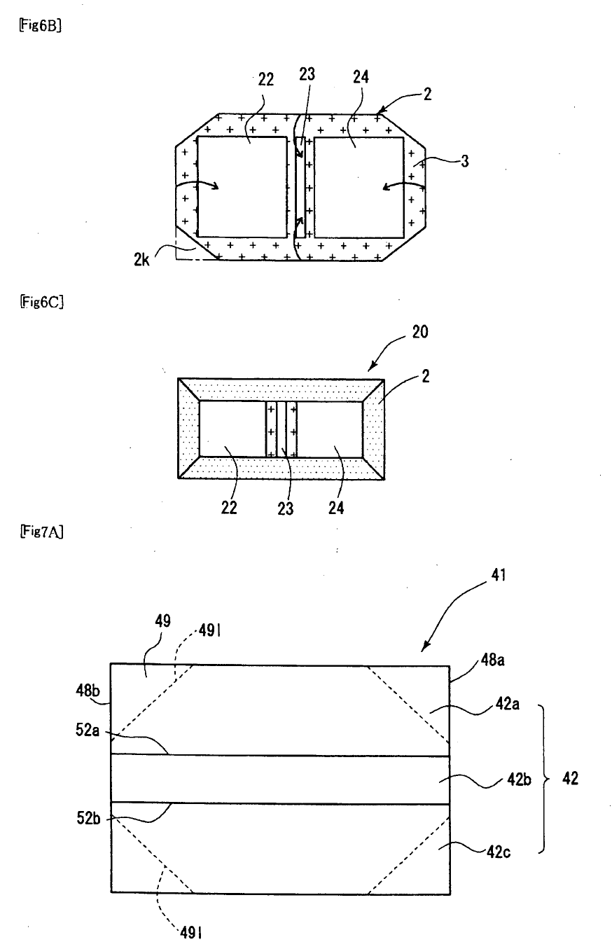

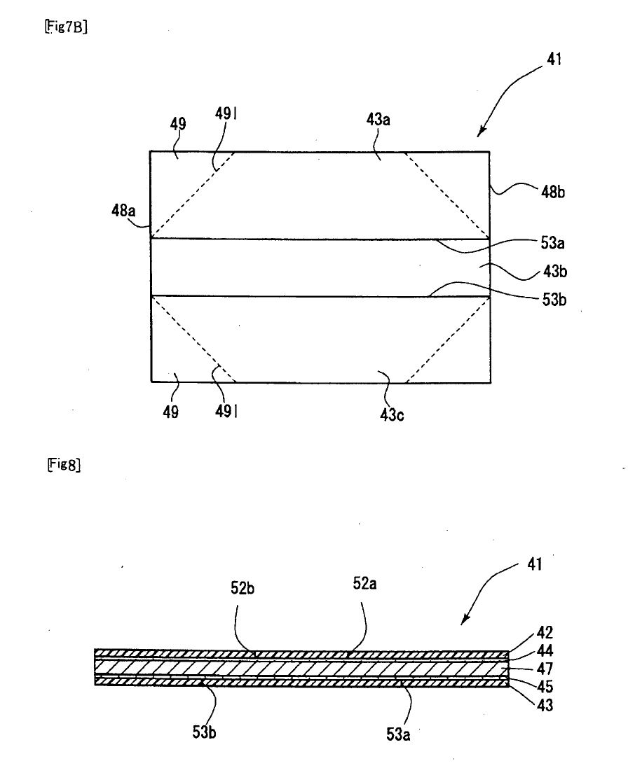

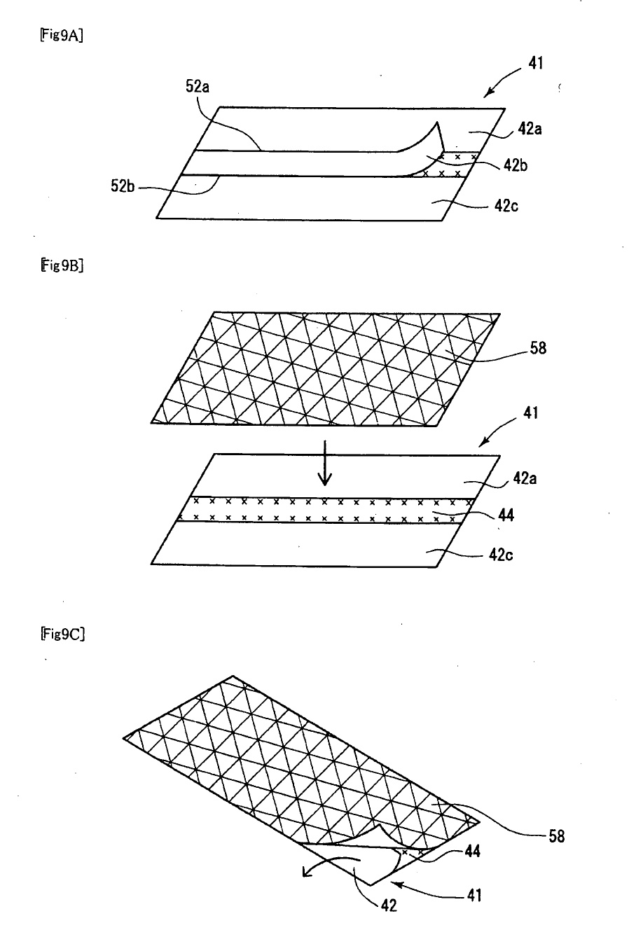

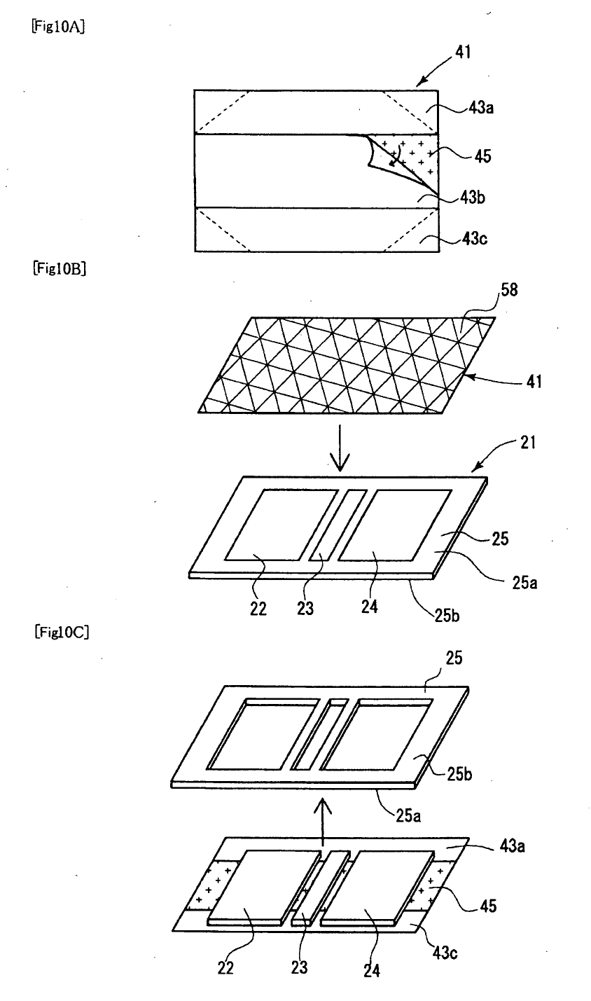

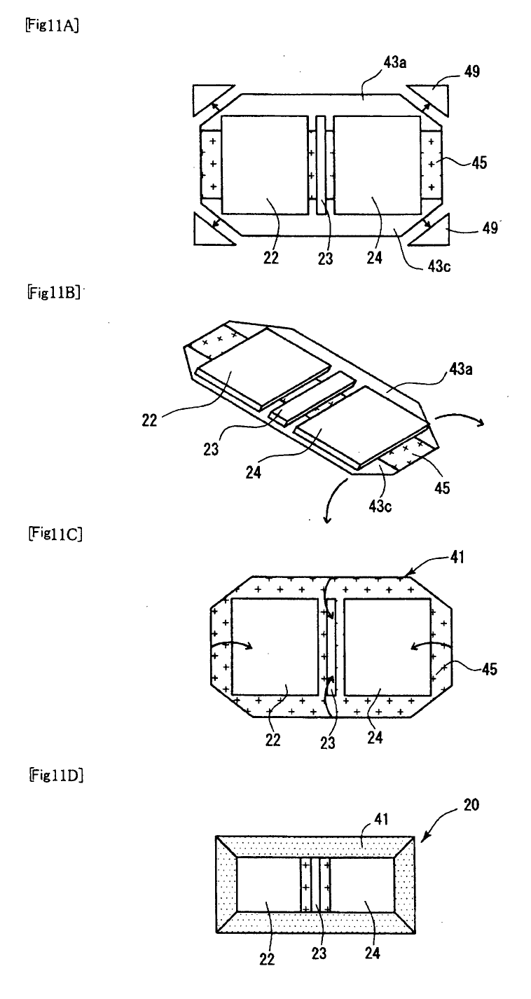

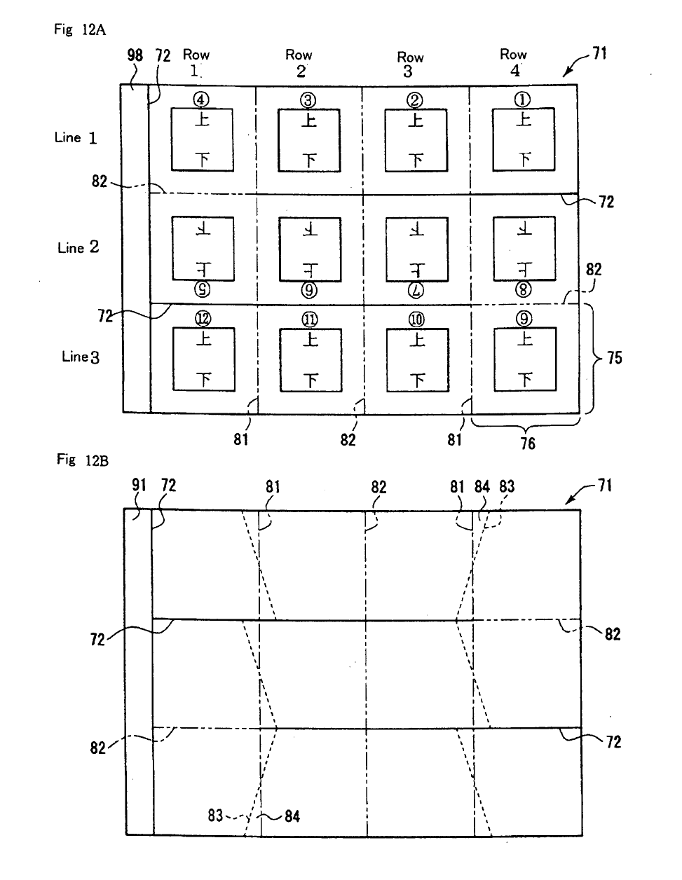

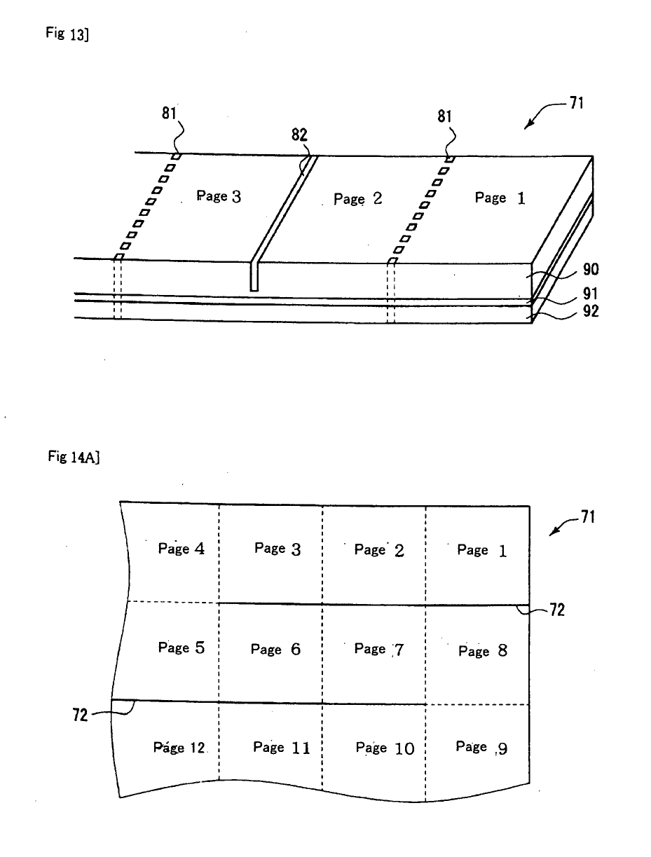

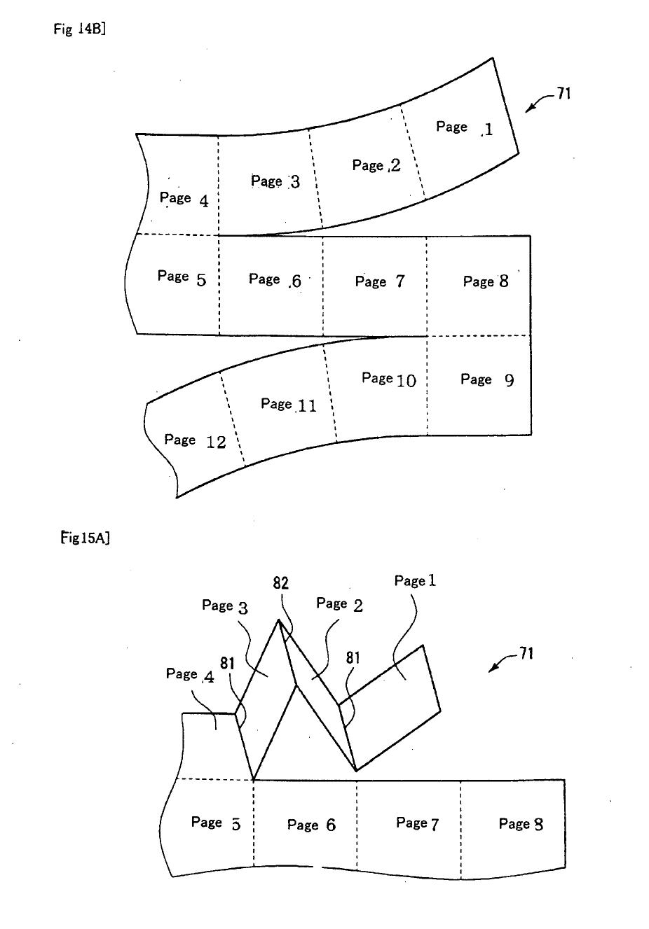

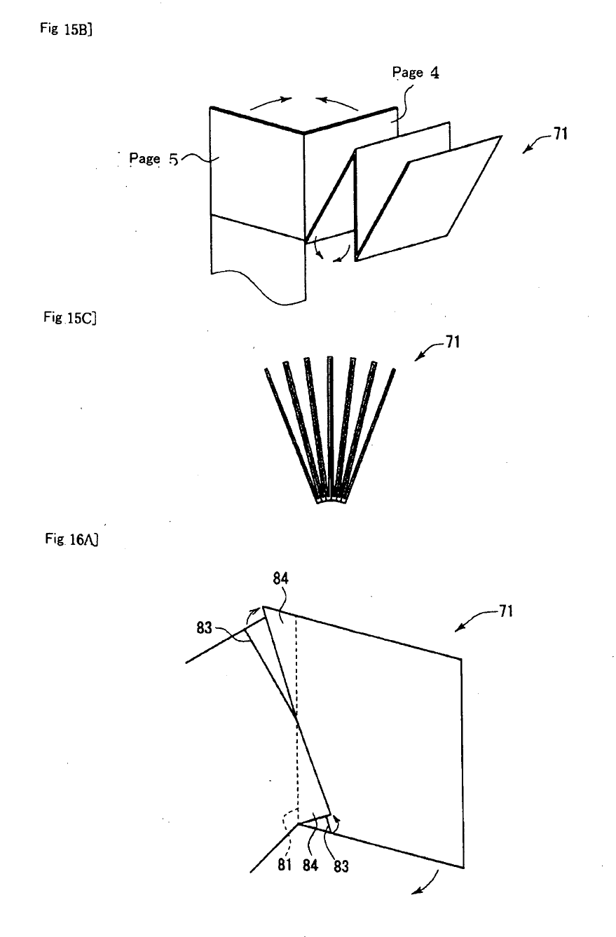

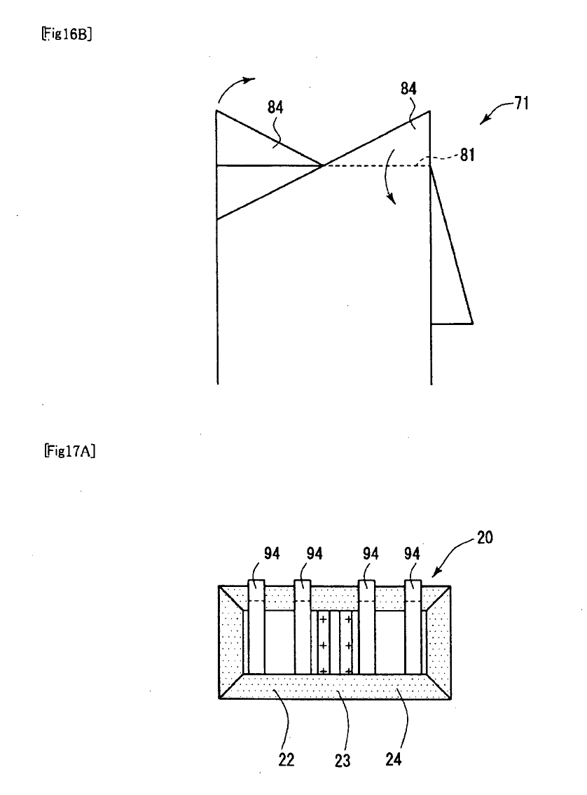

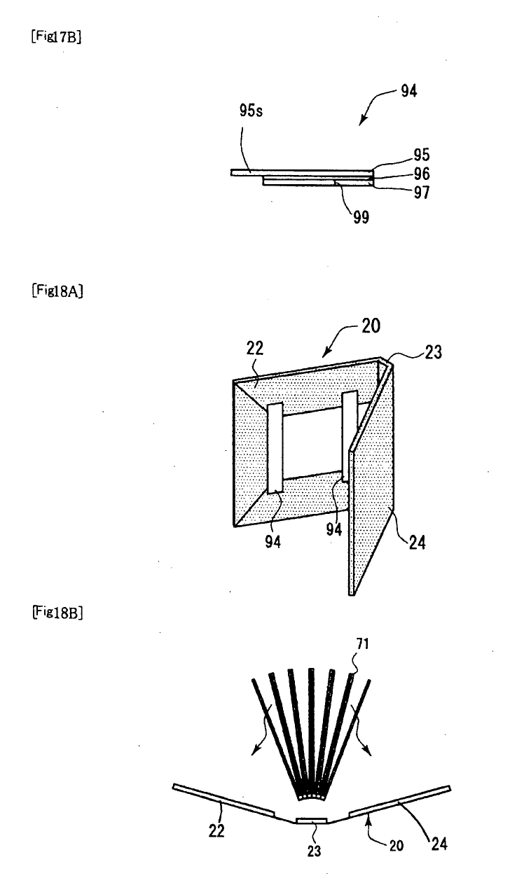

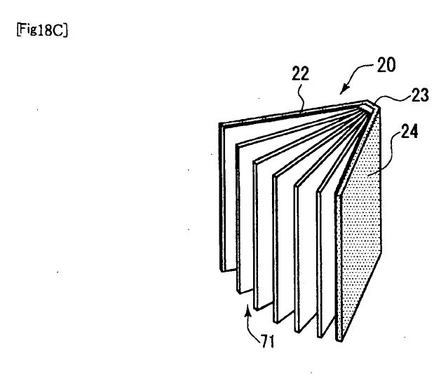

### BRIEF DESCRIPTION OF THE DRAWINGS

[FIG. 1A] The front surface of booklet cover sheet

[FIG. 1B] The rear surface of booklet cover sheet

[FIG. 2 ] Cross section of booklet cover sheet

[FIG. 3] Cover core components

[FIG. 4A] Assemble process of booklet cover using cover sheet

[FIG. 4B] The process of succeeding FIG. 4A

[FIG. 4C] The process of succeeding FIG. 4B

[FIG. 5A] The process of succeeding FIG. 4C

[FIG. 5B] The process of succeeding FIG. 5A

[FIG. 6A] The process of succeeding FIG. 5B

[FIG. 6B] The process of succeeding FIG. 6A

[FIG. 7A] The front surface of both side adhesive pressure sensitive sheet

[FIG. 7B] The rear surface of both side adhesive pressure sensitive sheet

[FIG. 8] Cross section of both side adhesive pressure sensitive sheet

[FIG. 9A] Assemble process of booklet cover using both side adhesive pressure sensitive sheet

[FIG. 9B] The process of succeeding FIG. 9A

[FIG. 9C] The process of succeeding FIG. 9B

[FIG. 10A] The process of succeeding FIG. 9C

[FIG. 10B] The process of succeeding FIG. 10A

[FIG. 10C] The process of succeeding FIG. 10B

[FIG. 11A] The process of succeeding FIG. 10C

[FIG. 11B] The process of succeeding FIG. 11A

[FIG. 11C] The process of succeeding FIG. 11B

[FIG. 11D] The process of succeeding FIG. 11C

[FIG. 12A] The execution sample of printing paper

[FIG. 12B] The execution sample of rear side of printing paper

[FIG. 13] Cross section of printing paper and explanation of bending line

[FIG. 14A] The process of printing paper after printing

[FIG. 14B] The process of succeeding FIG. 14A

[FIG. 15A] The process of succeeding FIG. 14B

[FIG. 15B] The process of succeeding FIG. 15A

[FIG. 15C] The process of succeeding FIG. 15B

[FIG. 16A] The explanation of peeling of releasing paper

[FIG. 16B] The tab portion of peeling

[FIG. 17A] The explanation of auxiliary sheet

[FIG. 17B] Cross section of auxiliary sheet

[FIG. 18A] The side view of booklet cover

[FIG. 18B] The adhesion with assembled printing paper and booklet cover

[FIG. 18C] The finish of booklet

### EMBODIMENT OF THE INVENTION

By referring the figure, the form of this invention is explained.

### Execution Example 1

FIG. 1 is the booklet cover sheet 1 of this invention. FIG. 1 (A) is the surface of booklet cover sheet 1. The booklet cover sheet 1 is formed by cover seal 2 on which the rear side is adhesive layer 3 (see FIG. 2). Putting adhesion layer 3, there is the seal 2 and releasing paper 7.

The surface of cover seal 2 is ready to print by inkjet printer. FIG. 1 (B) is the rear face of cover sheet 1. The total rear face of cover sheet 1 is formed by releasing paper 7. The releasing paper 7 is formed by central belt zone 7b which is formed in center from the edge of one side 11a to the other edge 11b to longitudinal direction and both sides of said center belt zone 7b are the first side of said releasing paper 7a and the second side of said releasing paper 7c.The releasing paper 7 is formed 3 zones by cutting line 12a and 12b.

FIG. 2 is the cross section of cover sheet 1. Adhesive layer is formed the rear face of cover seal 2. Putting adhesion layer 3, there is the releasing paper 7. The releasing paper 7 is formed 3 zones the first side releasing zone 7a, center zone 7b second zone 7c by cutting line 12a and 12b.

The cover seal 2 which is formed on cover sheet 1 is useful for printable surface 4. It is possible to make printing on the surface of cover seal 2 on which the cover sheet 1 is put into the inkjet printer. Printing is done by general usage software. Users can get the good pattern and good color what they like.

FIG. 3 is the cover core components 21. By stamping and paper material, said cover core components 21 is formed flame-body 25 which is possible to remove from other components and first cover component 22, back-bone core component 23 and second core component 24 and said first component 22 and back-bone component 23 and second component 24 are maintained specified interval. First core component 22 and second core component 24 are stamped same size and it become to front cover and rear cover of booklet.

Said first core component 22 and back-bone core component 23 and second core component form the booklet cover. It is recommend to have good hardness, strength and thickness. It is not restricted to use paper only for cover core components 21. It is possible to use other materials like plastics and metals by molding or by punching.

Said cover sheet 1 and cover core components 21 is designed same size and stamped.

It is very good for making positioning and adhesion with cover sheet 1 and cover core components 21. is explained later.

FIG. 4 and FIG. 5 and FIG. 6 explain the assemble process of booklet cover 20.

Prepare the cover sheet 1 and cover core component 21 which are included in the booklet cover kit. FIG. 4(A) shows that the cover seal 2 on the cover sheet 1 is not printed and is solid color. Cover seal 2 on said cover sheet 1 is printed what you like by inkjet printing or handwriting or hand painting and come to FIG. 4(B).

FIG. 4 (C) show the picture of releasing the center zone releasing paper 7b of releasing paper 7 that is on the rear side of the cover sheet 1. The adhesion layer 3 of said center zone is exposed.

And FIG. 5 (A) shows that the cover sheet 1 on which said adhesion layer 3 of said center zone is exposed is placed down on the cover core components 21a which is the front side of cover core components 21. It is easy to make positioning the corner of cover sheet 1 and cover core components which is designed same size. Using center zone of the exposed adhesion layer 3, make connection with cover sheet 1 and cover core components 21.
It is easy to make re-connection if the placement of the cover sheet 1 and the cover core components 21 is wrong, because of the partial usage of adhesion layer 3.

FIG. 5 (B) shows that said adhesion layer 3 of the cover sheet 1 is made soft connection with first cover core component 22 and back-bone core 23 and second core component 24.

After the good placement and good connection, the core flame 25 of the cover core components is taken off from the second side of cover core components 21.

And FIG. 6 (A) show that the adhesive layer 3 of the cover sheet 1 from which the first side of releasing paper 7a and second side of releasing paper 7c is peeled off is made hard connection with cover core component 22 and back-bone core 23 and second core component 24 of cover core components.

FIG. 6(B) shows what the outer area of cover seal is bent to inside.

FIG. 6(C) shows the finished product of booklet cover 20. The four corner 2k of said cover seal 2 is cut and it makes easy to bend from outside to inside of the outer cover area seal 2.

The cover sheet 1 is very good for coloring or decoration by inkjet printer or other printing technologies. It is very easy to get the booklet cover 20 what user like.

### Execution Example 2

FIG. 7 and FIG. 8 show the both side pressure sensitive sheet 41 of this invention. FIG. 7 (A) is the front surface of said sheet 41, FIG. 7(B) is the rear surface of said sheet 41, FIG. 8 is the cross section of said sheet 41. Said sheet has the base sheet 47 and first adhesive layer 41 and the second adhesive layer. Putting the both side adhesive layer 44 and 45, first releasing paper 42 is front side of base sheet and second releasing paper is rear side of base sheet.

FIG. 7 (A) show the front surface first releasing paper 42 of both side pressure sensitive sheet 41. The releasing paper 42 is formed by the central belt zone 42b which is formed in center from the edge of the side 42a to the other edge 42c to the longitudinal direction and both sides of said center belt zone 42b are the first side of said releasing paper 42a and second side of said releasing paper 42c.
The releasing paper 42 is formed 3 zones by cutting line 52a and 52b.

FIG. 7 (B) show the rear surface second releasing paper 43 of both side pressure sensitive sheet 41. The releasing paper 43 is formed by the central belt zone 4bb which is formed in center from the edge of the side 43a to the other edge 43c to the longitudinal direction and both sides of said center belt zone 43b are the first side of said releasing paper 43a and second side of said releasing paper 43c.

The releasing paper 43 is formed 3 zones by cutting line 53a and 53b.

The corner area of both side pressure sensitive sheet 41 is formed by cut off line 491 to take off from said both side pressure sensitive sheet. Said cut off lines 491 is made by dotted lines of perforation.

On said formed both side pressure sensitive sheet 41, the surface which is covered with the first surface of releasing paper 42 become adhesive surface with cover sheet 58, and the surface which is covered with the second releasing paper 43 become adhesive surface with cover core components.

FIG. 9 and FIG. 10 and FIG. 11 explain the assemble process of booklet cover 20.

Prepare the both side pressure sensitive sheet 41 and cover sheet 58 and cover core components 21 which is included in the booklet cover kit.

FIG. 9 (A) show the picture of releasing the center zone releasing paper 42b of the first releasing paper 42 that is on the surface of both side pressure sensitive sheet.

FIG. 9 (B) shows that the cover sheet 58 is placed down on the said both side pressure sensitive sheet 41 and soft connection with adhesive layer 44.

Said cover sheet 58 is the decoration of booklet cover surface. It is important to use what you like color or design and also the material of cover sheet 58 is accepted paper or vinyl or cloth or leather, etc.
It is easy to make arraignment with cover sheet 58 and cover core component 21 if use the same size.
It is possible to make re-place down of cover sheet 58 on the said both side pressure sensitive sheet 41 and connection again because of soft connection of adhesive layer 44. Adhesive layer 44 is used partial area. After the replace down, if there is no problem,
Said cover sheet 58 is hard adhered with both side pressure sensitive adhesive sheet 41 after peeling off the first side of releasing paper 42a and the second side of releasing paper 42c releasing paper of the first releasing paper.
The first releasing paper 42 is accepted without cutting lines 52a and 52b.
Said releasing paper is used as one sheet, but when taking off the releasing paper and all of adhesive layer 44 is active. Making placement with cover sheet 58 and said both side of adhesive pressure sensitive sheet 41 is difficult and after the wrong placement, it is very difficult to take off and make replacement. It is better that said releasing paper 42 have more than two releasing paper area.

FIG. 10(A) shows the rear side of both side adhesive pressure sensitive sheet 41.

The center area of adhesive layer 45 is exposed by peeling off the center belt zone releasing paper 43b of rear side of releasing paper of both side adhesive pressure sensitive sheet 41.

FIG. 10(B) shows the picture of releasing the center zone releasing paper 45 and is placed down the both side adhesive pressure sensitive paper 41 to the first side 21a of cover core components 21. This cover core components is as same as the execution 1.

The both side adhesive pressure sensitive sheet 41 and cover core components is soft connected by exposed adhesive layer 45.

FIG. 10(C) shows the picture of soft adhesion of both side of adhesive pressure sensitive paper 41 and the first core 22 and back-bone core 23 and second core 24 of cover core components 21. Then The flame cover component 25 of said cover core components 21 is removed from cover core components 21. It is possible to make adhesion with booklet cover with both side adhesion pressure sensitive sheet which is adhered with cover core components first.

FIG. 11 (A) shows the remove of the corner 49 from cutting line 491.

It is easier if cover sheet has the cutting lines on same corners.

FIG. 11 (B) shows the picture of adhesion of said both side of adhesive pressure sensitive sheet 41 and the first cover core component 22 and back-bone core component 23 and second core component 24 of cover core components 21 after the releasing of the first side releasing paper 43a and second side of releasing paper 43c of second releasing paper 43 of said both side adhesive pressure sensitive sheet 41.

FIG. 11(C) shows that the four corners of said both side adhesive pressure sensitive sheet is cut and bend from outside to inside of the outer cover area.

FIG. 11(D) shows the finished product of booklet cover 20. Booklet cover which is made by the execution example 1 or 2 is used for cover of process below.

FIG. 12A and FIG. 12B show execution sample of printing paper by which is made the album booklet. FIG. 12A shows the front surface of printing paper 71. The page area of identical size into 3 line 4 rows has lined up into said printing paper 71. The solid lines from above between 1^{st} line and second line, from the left 2^{nd} row to four row, from above between 2^{nd} line and 3^{rd} line, from left 1^{st} row to 3^{rd} row show the cutting lines 72. Number is marked from 1^{st} line 4^{th} row.

“Fold away from you” line 81 is formed between the 2^{st} page and the 2^{nd} page.
“Fold toward you” line 82 is formed between 2^{nd} page and 3^{rd} page.
Alternately “Fold away from you” line 81 and “Fold toward you” line are formed.
Printing paper 71 is A4 size and less than 12 pages pictures is printed. Said printing paper is not limited only this A4 size.
The position of images are decided and the direction of the images decided which is shown FIG. 12A on said printing paper, each image from the 1^{st} page to the 4^{th} page and from 9^{th} page to the 12^{th} page are printed in the same direction. From the 5^{th} page to the 8^{th} page are printed in the reverse direction. The order of printing is done in the order of showing. If users select the print form and appoint the order of printing, it is not necessary to do detailed setting of printing position or other settings. Application software takes care of these setting and makes forward the printing data to printer and said data is printed on said printing paper.
Said printing paper is A4 size and arranged the 12 pages with 4 rows of 3 lines. Each pages is formed with a square. The high quality imagination of booklet becomes from the square or near square image (75 and 76 is same length in FIG. 12A) Rest of page area 98 is shown FIG. 12A

The next paragraph FIG. 13 describe a sectional structure of printing paper 71, and the “Fold toward you” line and the “Fold away from you” line formed between every adjacent row. Printing paper 71 comprises a sheet 90 with page regions having a adhesive layer 91 on the back surface thereof and releasing paper 92 placed thereon.

Use of a glossy photo paper as sheet 90 can ensure a fine finish of printing. The use of relatively thick product, as thick as 180 μm for example, is preferable in terms of producing a touch of high quality. It is to be understood that the drawing emphasizes the direction of thickness.
As shown in FIG. 13, “Fold away from you” line 81 is given as a perforation line, “Fold toward you” line 82 is given as a half-slit. The half-slit is formed as cutting sheet 90 to a depth of half or ⅔ of the depth-wise direction thereof, allowing the residual depth to remain connected. In other word, it has a bottomed trenched structure. This facilitates the folding.
It is also allowable to give the perforation line as the “Fold toward you” line, and to give the half-slit as the “Fold toward you” line. It is still also allowable to give the perforation line as a micro-perforation line, so as to ensure cutting at the micro-perforation line when the printed paper is “Fold toward you” at the micro-perforation line.
This ensures a good looking booklet having a relatively large number of pages.

The cover and rear surface can be bonded with each other by peeling off the releasing paper 92 from the rear surface. Releasing paper 92 is formed therein a release-assist formation line 83 which is cutting line and cross to perforation line or half-slit line and which facilitates the peeling of releasing paper 92.

A weak adhesive agent composing adhesive layer 91 is preferable to enable re-peeling.

In the case where printing paper 80 having a base weight 100 gr/m² or more and a thickness of 180 μm or more is used, usage of a adhesive having a tackiness of 12 Newton/25 mm or less allows peeling- off and re-adhesion, even if the position of bonding have to shift good position during the bonding process. Referring back to FIG. 12B, the rear surface of printing paper is explained. The rear surface of printing paper is covered with releasing paper 92 (see FIG. 13). Releasing paper 92 has a releasing-assist formation line 83 therein. As shown FIG. 12B, releasing- assist formation line 81 is diagonally formed as extending from “Fold away from you” line 81.
Releasing-assist formation line 83 and “Fold away from you” line 81 and the edges of the printing paper or cutting line 72 form the tab portion 84. Releasing-assist formation is a slit formed on releasing paper 92, and is not formed on printing paper 90.

After printing, cutting line 72 of printing paper 71 which is expressed by the solid line shown in FIG. 12A is cut. The portion expressed by the dotted line is not cut.

By folding the portions expressed by the dotted line in “Away from you” and “Toward you”, an album booklet can be obtained which have the images printed therein according to predetermined order.

FIG. 14A and FIG. 14B show the cutting between each page areas.

The cutting line 72 is formed in FIG. 14A. After the printing the picture or photo, etc, on the printing paper 71 Cutting line 72 is cut as shown FIG. 14B. FIG. 14B shows the cutting is performed by cutting lines which is formed between first line and second line, between second line and third line.
FIG. 15A shows the cutting between first line and second line and forming between “Fold away from you” 81 and “Fold toward you” 82 of printing paper and bending of printing paper. In “Fold away from you” line of a border of page area 1 and page area 2, it is done in “Fold away from you”. It is done in “Fold toward you” line of page area 2 and page area 3 in “Fold toward you”. It is done in “Fold away from you” line of page area 3 and page area 4 next in “Fold toward you”. And it is done in “Fold toward you” line of a border of page area 4 and page area 5 in “Fold toward you” as shown in FIG. 15B. About a boundary line of a page area of the second line and third line, it is bended in the same procedure as follows. It is made adhesive together in the rear side of a page area by peeling off the releasing paper 92 which is said page area FIG. 15C shows the booklet.

FIG. 16A and FIG. 16B show the process of peeling-off of the releasing paper for bonding of the printing paper. FIG. 16A shows the rear surface of printing paper 71. The rear surface of printing paper 71 is formed therein releasing-assist formation line 83 which is positioned diagonally to “Fold away from you” line 81. Releasing-assist formation line 83 is configured as a slit formed on the releasing paper, wherein the slit dose not reach to printing paper 90 on which printing is performed.

By folding at folding line 81 between the page region as shown in FIG. 16B, the tab portion 84 of the releasing paper is peeled off from releasing-assist formation line 83. The tab portion 84 can be manipulated by fingers, and pulled in the direction indicated by the arrow shown in FIG. 16B and peeled off from releasing paper.
By forming the tab portion in the vicinity of the folding line as described in the above, the tab portion 84 is peeled off when the printing paper 71 is folded at the folding line because of the smallness of the area and the weakness of the tackiness of tab portion 84.
This makes it possible to peel off the releasing paper 92 by picking the tab portion 84 thereof.
The shape of tab potion is not limited to described one. Provided that the tab can be peeled off from the adhesive layer upon being folded, any geometric shape will suffice. For this reason, the tab portion 84 with a small area is preferred, whereby a larger area would result in a adhesive tolerant enough to withstand the folding, and would fall in peeling off of the tab portion 84 even if the printing paper is folded.

FIG. 17A shows the both sides pressure sensitive auxiliary materials 94 which bond to the both in-sides of booklet cover 20. Said auxiliary materials 94 is composed the base sheet which are both sides adhesive sheet 96 and the first releasing paper which is formed largely in longitudinal than said base sheet 96 and the second releasing paper 97 which is same size of base sheet 96.

The second releasing paper 97 is formed slitting 99 and is easy to peel off and adhere to booklet cover 20 as shown FIG. 17A. After the adhesion of said auxiliary materials, the end of first releasing paper 95 is over the cover sheet 20 and it is easy to peeling off the releasing paper. The adhesion with said auxiliary materials and said book cover makes strong connection with printing paper 71 and booklet cover 20.

FIG. 18A show the perspective view of the finished booklet cover. The surface of booklet cover is covered with cover 58 or cover seal 2 for booklet, and showing a good design. As shown in FIG. 18B, printing paper 71 (fold section) obtained by folding and bundling in the said process steps is attached to booklet cover 20.

FIG. 18C is the final album booklet.

As explained above, users can make the booklet cover easily what they like by using the cover sheet 1 and cover core components or can make the booklet cover easily what they like by using both side adhesive pressure sensitive sheet 41, cover core components and cover sheet 58.

1. A method of creating a booklet cover, comprising:
preparing:
a coversheet including:
a cover sticker having an adhesion layer formed on a back surface thereof; and
a releasing paper adhered, peelable to the cover sticker, on the back surface of the cover sticker having the adhesive layer therebetween, having a splitting section, peelable by splitting into at least two, formed along in a longitudinal direction form an edge of one side to that of the other; and
an interlining including:
a back cover member to be a back cover of a booklet;
a first cover member contiguous to the back cover member having space therebetween;
a second cover member contiguous having space therebetween, opposite to the first cover member of the back cover member; and
a frame detachable to these back cover member, first cover member and second cover member; and
peeling a part of the releasing paper, and then disposing the coversheet over a first surface of the interlining;
adhering the back cover member, the first cover member and the second cover member with the adhesion layer of the cover sticker to be fixed, so as to detach the remaining frame; and further
peeling off the remaining releasing paper, and then covering the first cover member, the second cover member and the back cover member unitedly with the cover sticker, so as to be booklet cover.

2. The method of creating the booklet cover according to claim 1, comprising:
disposing the preprinted coversheet over the first surface of the interlining, after peeling a part of the releasing paper.

3. A method of creating a booklet cover, comprising
preparing:
a double-sided adhesion sheet including:
a base sheet having adhesion layers formed on both sides thereof;
a first releasing paper adhered, peelable to the base sheet, on a first surface of the base sheet having the adhesive layer therebetween, having a splitting section, peelable by splitting into at least two, formed along in a longitudinal direction form an edge of one side to that of the other; and
a second releasing paper adhered, peelable to the base sheet, on a second surface of the base sheet having the adhesive layer therebetween, having a splitting section, peelable by splitting into at least two, formed along in a longitudinal direction form an edge of one side to that of the other;
a cover; and
an interlining including:
a back cover member to be a back cover of a booklet;
a first cover member contiguous to the back cover member having space therebetween;
a second cover member contiguous having space therebetween, opposite to the first cover member of the back cover member; and
a frame detachable to these back cover member, first cover member and second cover member; and
peeling a part of the first releasing paper so as to fix the cover to the base sheet, and then peeling the remaining first releasing paper so as to fix the entire cover to the base sheet,
before or after the above, peeling a part of the second releasing paper so as to dispose the double-sided adhesion sheet over a first surface of the interlining, and then adhering the first cover member, the second cover member and the back cover member with the adhesion layer of the base sheet to be fixed so as to detach the remaining frame; and further
peeling off the remaining second releasing paper, and then covering the first cover member, the second cover member and the back cover member unitedly with the cover and the base sheet so as to be booklet cover.

4. The method of creating the booklet cover according to claim 3, comprising:
adhering the first cover member, the second cover member and the back cover member with the adhesion layer of the base sheet to be fixed, so as to detach the remaining frame; then
in order to cover the first cover member, the second cover member and the back cover member with the cover and the base sheet, cutting respective four corners of the cover and the base sheet as an unity; and further
peeling off the remaining releasing paper, and then covering the first cover member, the second cover member and the back cover member unitedly with the cover and the base sheet so as to be booklet cover.

5. A booklet cover kit comprising:
a coversheet including:
a cover sticker, to be printed on a surface thereof, having an adhesion layer formed on a back surface thereof; and
a releasing paper adhered, peelable to the cover sticker, on the back surface of the cover sticker having the adhesive layer therebetween, having a splitting section, peelable by splitting into at least two, formed along in a longitudinal direction form an edge of one side to that of the other; and
an interlining including:
a back cover member to be a back cover of a booklet;
a first cover member contiguous to the back cover member having space therebetween;
a second cover member contiguous having space therebetween, opposite to the first cover member of the back cover member; and
a frame detachable to these back cover member, first cover member and second cover member; wherein
after peeling a part of the releasing paper, the coversheet is to be disposed over a first surface of the interlining, then the back cover member, the first cover member and the second cover member are to be adhered with the adhesion layer of the cover sticker to be fixed so as to detach the remaining frame, and further after peeling off the remaining releasing paper, the first cover member, the second cover member and the back cover member are to be covered unitedly with the cover sticker so as to be booklet cover.

6. The booklet cover kit according to claim 5, wherein the releasing paper of the coversheet comprises:
a center portion formed in a center area along in a longitudinal direction form an edge of one side thereof to that of the other; and
a first side portion and a second side portion on both sides of the center portion.

7. The booklet cover kit according to claim 5, wherein the cover sticker of the cover sheet has four corners having been cut respectively.

8. A booklet cover kit comprising:
a double-sided adhesion sheet including:
a base sheet having adhesion layers formed on both sides thereof;
a first releasing paper adhered, peelable to the base sheet, on a first surface of the base sheet having the adhesive layer therebetween; and
a second releasing paper adhered, peelable to the base sheet, on a second surface of the base sheet having the adhesive layer therebetween, having a splitting section, peelable by splitting into at least two, formed along in a longitudinal direction form an edge of one side to that of the other;
an interlining including:
a back cover member to be a back cover of a booklet;
a first cover member contiguous to the back cover member having space therebetween;
a second cover member contiguous having space therebetween, opposite to the first cover member of the back cover member; and
a frame detachable to these back cover member, first cover member and second cover member; wherein
after peeling the first releasing paper so as to fix a cover to the base sheet,
before or after the above, peeling a part of the second releasing paper so as to dispose the double-sided adhesion sheet over a first surface of the interlining, the first cover member, the second cover member and the back cover member are to be adhered with the adhesion layer of the base sheet to be fixed so as to detach the remaining frame and further
after peeling off the remaining second releasing paper, the first cover member, the second cover member and the back cover member are to be covered unitedly with the cover and the base sheet so as to be booklet cover.

9. A booklet cover kit comprising:
a double-sided adhesion sheet including:
a base sheet having adhesion layers formed on both sides thereof;
a first releasing paper adhered, peelable to the base sheet, on a first surface of the base sheet having the adhesive layer therebetween, having a splitting section, peelable by splitting into at least two, formed along in a longitudinal direction form an edge of one side to that of the other; and
a second releasing paper adhered, peelable to the base sheet, on a second surface of the base sheet having the adhesive layer therebetween, having a splitting section, peelable by splitting into at least two, formed along in a longitudinal direction form an edge of one side to that of the other;
an interlining including:
a back cover member to be a back cover of a booklet;
a first cover member contiguous to the back cover member having space therebetween;
a second cover member contiguous having space therebetween, opposite to the first cover member of the back cover member; and
a frame detachable to these back cover member, first cover member and second cover member; wherein
after peeling a part of the first releasing paper so as to fix a cover to the base sheet, the remaining first releasing paper is to be peeled so as to fix the entire cover to the base sheet,
before or after the above, peeling a part of the second releasing paper so as to dispose the double-sided adhesion sheet over a first surface of the interlining, the first cover member, the second cover member and the back cover member are to be adhered with the adhesion layer of the base sheet to be fixed so as to detach the remaining frame and further
after peeling off the remaining second releasing paper, the first cover member, the second cover member and the back cover member are to be covered unitedly with the cover and the base sheet so as to be booklet cover.

10. The booklet cover kit according to claim 9, wherein the first releasing paper of the adhesion sheet comprises:
a center portion formed in a center area along in a longitudinal direction form an edge of one side thereof to that of the other; and
a first side portion and a second side portion on both sides of the center portion.

11. The booklet cover kit according to claim 8, wherein the second releasing paper of the adhesion sheet comprises:
a center portion formed in a center area along in a longitudinal direction form an edge of one side thereof to that of the other; and
a first side portion and a second side portion on both sides of the center portion.

12. The booklet cover kit according to claim 8, including a cover to be adhered to the double-sided adhesion sheet.

13. The booklet cover kit according to claim 8, wherein the double-sided adhesion sheet has cutting lines formed at four corner portions, in order to cut off the corner portions respectively.

14. The booklet cover kit according to claim 5, including a double-sided adhesion reinforcing member comprising:
a base member having adhesive layers formed on both sides thereof;
a first releasing paper adhered, peelable to the base member, to a first surface of the base member having the adhesive layer therebetween, and formed larger that the base member in a longitudinal direction; and
a second releasing paper adhered, peelable to the base member, to a second surface of the base member having the adhesive layer therebetween, wherein
the second releasing paper is to be peeled so as to adhere the booklet cover, and the first releasing paper is to be peeled so as to adhere a quire formed of printing papers printed to be the booklet.

15. The booklet cover kit according to claim 9, wherein the second releasing paper of the adhesion sheet comprises:
a center portion formed in a center area along in a longitudinal direction form an edge of one side thereof to that of the other; and
a first side portion and a second side portion on both sides of the center portion.

16. The booklet cover kit according to claim 9, including a cover to be adhered to the double-sided adhesion sheet.

17. The booklet cover kit according to claim 9, wherein the double-sided adhesion sheet has cutting lines formed at four corner portions, in order to cut off the corner portions respectively.

18. The booklet cover kit according to claim 8, including a double-sided adhesion reinforcing member comprising:
a base member having adhesive layers formed on both sides thereof;
a first releasing paper adhered, peelable to the base member, to a first surface of the base member having the adhesive layer therebetween, and formed larger that the base member in a longitudinal direction; and
a second releasing paper adhered, peelable to the base member, to a second surface of the base member having the adhesive layer therebetween, wherein
the second releasing paper is to be peeled so as to adhere the booklet cover, and the first releasing paper is to be peeled so as to adhere a quire formed of printing papers printed to be the booklet.

19. The booklet cover kit according to claim 9, including a double-sided adhesion reinforcing member comprising:
a base member having adhesive layers formed on both sides thereof;
a first releasing paper adhered, peelable to the base member, to a first surface of the base member having the adhesive layer therebetween, and formed larger that the base member in a longitudinal direction; and
a second releasing paper adhered, peelable to the base member, to a second surface of the base member having the adhesive layer therebetween, wherein
the second releasing paper is to be peeled so as to adhere the booklet cover, and the first releasing paper is to be peeled so as to adhere a quire formed of printing papers printed to be the booklet.
